(19) United States
(12) Patent Application Publication
(10) Pub. No.: US 2007/0096484 A1
(43) Pub. Date: May 3, 2007

(54) Cosmetic pencil sharpener, eyelash curler and tweezers

(76) Inventors: John Maldonado, Venice, CA (US); Victoria Wood, Venice, CA (US)

Correspondence Address: HOFFMAN, WASSON & GITLER, P.C., Crystal Center 2, Suite 522, 2461 South Clark Street, Arlington, VA, 22202, US

(21) Appl. No.: 11/440,406

(22) Filed: May 25, 2006

Related U.S. Application Data
(60) Provisional application No. 60/684,181, filed on May 25, 2005.

(51) Int. Cl. B25B 9/02

(52) U.S. Cl. 294/99.2

(57) ABSTRACT

A cosmetic pencil sharpener has two sharpening blades molded in the side. Behind the sharpening blade is a cavity leading to openings in the bottom, one opening for each blade. A shield covers the openings in the bottom of the pencil sharpener. An eyelash curler has two handles pressed together in order to have push-up bars move a lower grommet upward into an upper grommet. Eyelashes placed between the two grommets are curved by this action. The top profile of the lower grommet is rounded and slanted to produce a natural smooth curl. Tweezers have both a blunt portion and a slanted portion forming the tip. Comfort foam grips, contoured to comfortably fit a fingertip, are placed on the bottom and top of the tweezers for placement of fingers when squeezing the tweezers.

This application claims the benefit of provisional application 60/684,181, filed May 25, 2006.

### BACKGROUND OF THE INVENTION

The application of make-up is facilitated by many tools. Cosmetic pencils need to be sharpened to achieve best results. Also, eyelash curlers and tweezers are needed to prepare someone before make-up is applied. Most of these tools; sharpeners, curlers and tweezers, are very basic in design and do, at best, an adequate job.

It is an object of the invention to provide cosmetic tools that are simple to use.

It is another object of the invention to provide cosmetic tools that lead to better results for the user.

This and other objects of the invention will be apparent to one of ordinary skill in the art after reading the disclosure of the invention.

### SUMMARY OF THE INVENTION

A cosmetic pencil sharpener has two sharpening blades molded in the side. Behind the sharpening blade is a cavity leading to openings in the bottom, one opening for each blade. A shield covers the openings in the bottom of the pencil sharpener. An eyelash curler has two handles pressed together in order to have push-up bars move a lower grommet upward into an upper grommet. Eyelashes placed between the two grommets are curved by this action. The top profile of the lower grommet is rounded and slanted to produce a natural smooth curl. Tweezers have both a blunt portion and a slanted portion forming the tip. Comfort foam grips, contoured to comfortably fit a fingertip, are placed on the bottom and top of the tweezers for placement of fingers when squeezing the tweezers.

### BRIEF DESCRIPTION OF THE DRAWINGS

FIG. 1 is a perspective view of the cosmetic pencil sharpener;

FIG. 2a is a top view of a shield;

FIG. 2b is a perspective view of the rails;

FIG. 2c is a top view of the shield retained by the rails;

FIG. 3a is a side view of the eyelash curlers;

FIG. 3b is a top view of the eyelash curlers;

FIG. 4a is a side view of the tweezers; and

FIG. 4b is a top view of the tweezers.

### DETAILED DESCRIPTION OF THE INVENTION

A cosmetic pencil sharpener 10 has two sharpening blades 12,14 molded in the side, as seen in FIG. 1. Behind the sharpening blade is a cavity leading to openings in the bottom, one opening for each blade. The pencil sharpener is inserted through the opening in the bottom and rotated so that the pencil comes in contact with the blade and is sharpened. Shavings fall away from the blade and into a plastic dome 16 hingedly attached to the side of the pencil sharpener. The shavings can be emptied from the dome at a later time.

FIG. 1 shows a magnet 18 placed within the dome and a second magnet in the side of the pencil sharpener to maintain the dome in a closed position. The magnet may be made in any appropriate size, such as 7/32 inches in diameter and placed in any suitable location to keep the dome securely closed.

FIG. 2a shows a shield 20 for covering the openings in the bottom of the pencil sharpener. When the pencil is sharpened, some shavings will fall down within the pencil sharpener and not into the dome. The shield covers the openings to prevent the shavings from coming out of the compact at an unwanted time. Rail guards 22 depicted in FIG. 2b are attached to the bottom of the pencil sharpener, such as unitarily forming them with the bottom wall. The shield is sized to be retained between the rail guards as seen in FIG. 2c and notches 24 within the side of the shield allow the shield to be easily grasped and removed to either access the openings in the bottom of the pencil sharpener or to clean.

FIGS. 3a and 3b depict an eyelash curler 30 having two handles 32 which are pressed together in order to have push-up bars move a lower grommet 34 upward into an upper grommet 36. Eyelashes placed between the two grommets are curved by this action. The top profile of the lower grommet 34 is rounded and slanted to produce a natural smooth curl. In addition, the upper portion of the eyelash curler is rounded as can be seen in the figures to fit comfortably underneath the frontal bone near the eye. The handles are shaped for comfort and easy positioning of the curler.

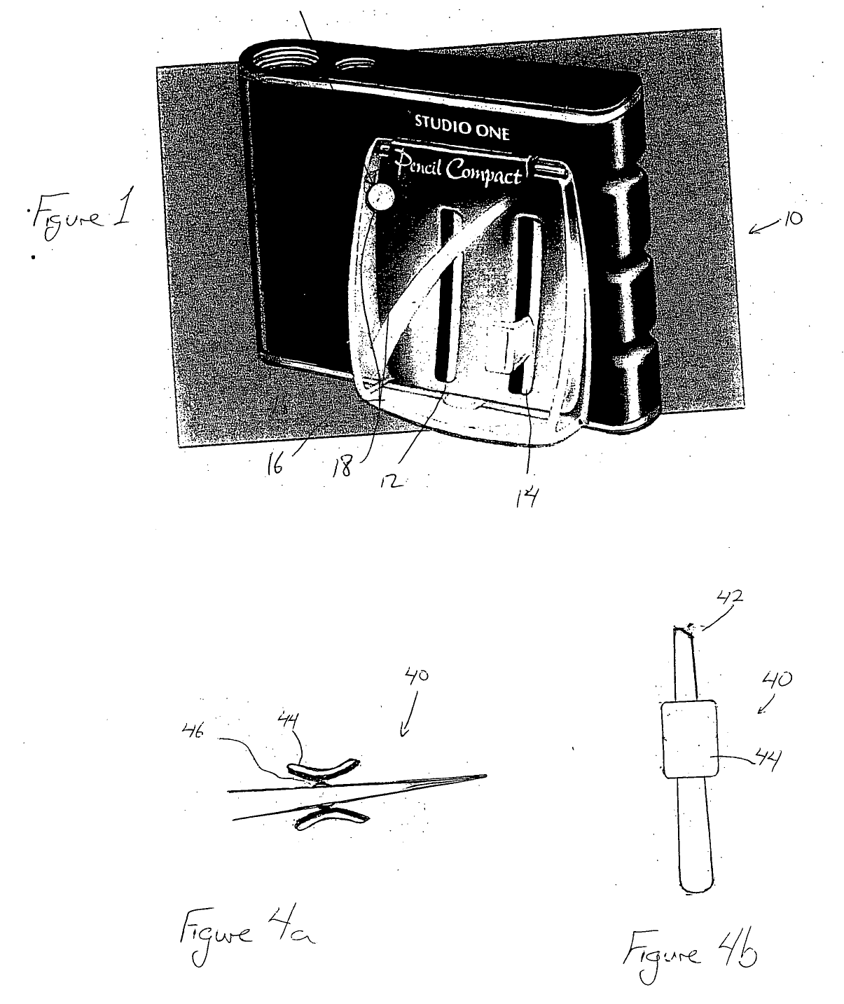

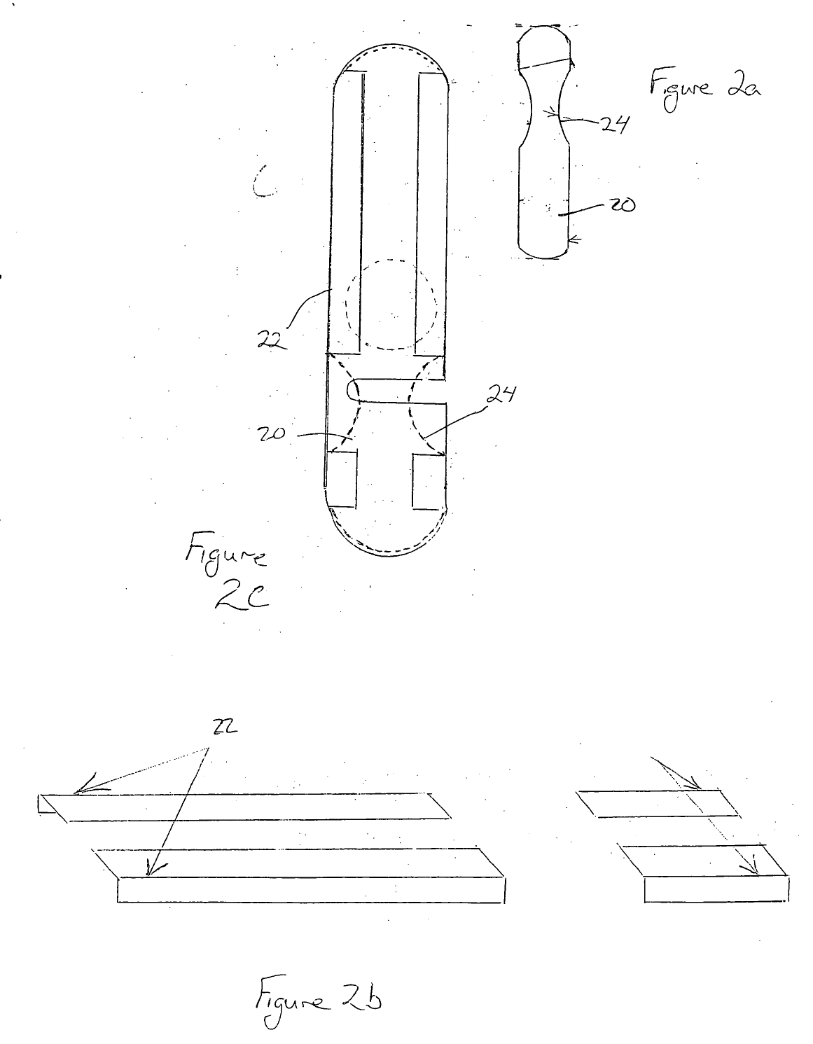

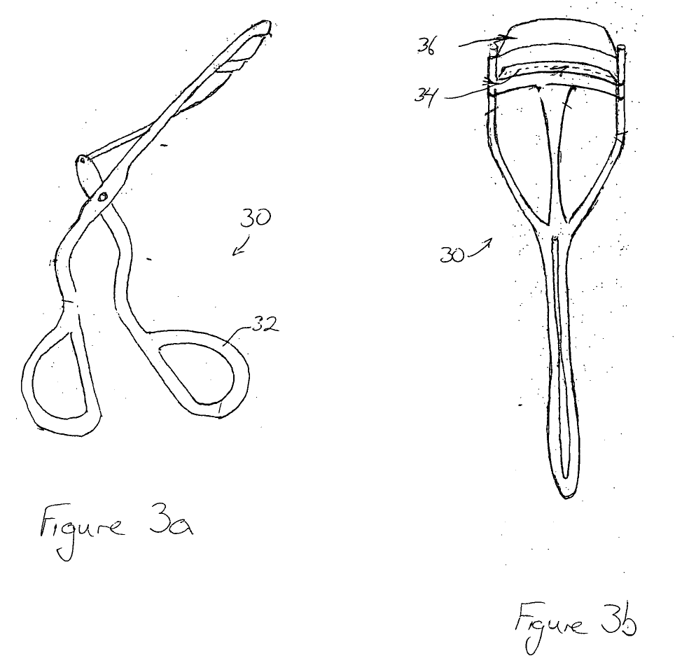

FIGS. 4a and 4b shows the side and top views of tweezers 40. As seen in the top view, the end 42 of the tweezers have both a blunt portion and a slanted portion forming the tip. Comfort foam grips 44, contoured to comfortably fit a fingertip, such as concave, are placed on the bottom and top of the tweezers for placement of fingers when squeezing the tweezers. The side view can be seen the contour of the comfort foam grips and their swivel connection 46 to the tweezers. The swivel connection can be formed in any conventional manner, such as a resilient connection between the grip and a protrusion extending from the surface of the tweezers.

While the invention has been described with reference to preferred embodiments, variations and modifications would be apparent to one of ordinary skill in the art. The invention encompasses such variations and modifications.

1. A pair of tweezers, comprising
a pair of arms connected to one another, each arm having an end,
the end of each arm having a blunt and slanted portion, and
a grip connected to each arm, said grip attached to said arm by a swivel connection.
